(19) United States
(12) Patent Application Publication
(10) Pub. No.: US 2016/0026292 A1
(43) Pub. Date: Jan. 28, 2016

(54) CIRCUIT CONNECTION STRUCTURE OF TOUCH SENSOR PANEL

(71) Applicant: ETURBOTOUCH TECHNOLOGY INC., Taoyuan (TW)

(72) Inventors: KUEI-CHING WANG, Taoyuan (TW); TA-HU LIN, Taoyuan (TW)

(21) Appl. No.: 14/583,086

(22) Filed: Dec. 24, 2014

Related U.S. Application Data
(63) Continuation-in-part of application No. 14/341,845, filed on Jul. 28, 2014.

(51) Int. Cl. G06F 3/044

(52) U.S. Cl. CPC G06F 3/044

(57) ABSTRACT

Disclosed is a capacitive touch sensor panel. The panel includes a first substrate, a second substrate, a first conductive connecting layer, a second conductive connecting layer, an insulative opaque layer, and a grounding layer. Each substrate comprises a sensing region and a connecting region surrounding the sensing region. The first conductive connecting layer is disposed on the first substrate in the connecting region. The insulative opaque layer is disposed on the second substrate while the grounding layer may be disposed above or under the insulative opaque layer and, at the same time, disposed above the first conductive connecting layer. The second conductive connecting layer is disposed under the insulative opaque layer and may be adjacent to the grounding layer.

### CROSS REFERENCE TO THE RELATED APPLICATIONS

This application is a continuation-in-part application of U.S. patent application Ser. No. 14/341,845, which is field in Jul. 28, 2014.

### FIELD

The present disclosure herein relates to a touch sensor panel. More specifically, the present disclosure relates to a circuit connection structure of capacitive touch sensor panel.

### BACKGROUND

Various types of touch input devices are widely used with electronic products. For instance, mobile phones and tablet personal computers typically utilize touch panels as input interfaces, such that users may perform touch operations on the touch panels to input commands, e.g. drag a finger to move a cursor or write words on the touch panels. Also, the touch panels may cooperate with displays to show virtual buttons, which may be selected by the user to input characters and words.

In general, a touch sensor panel may be a resistive, capacitive, supersonic, or infrared touch panel, Among these, the capacitive touch sensor panel senses a change of capacitance that is formed by a conductive layer and another conductive layer when a user's hand or an object is touched thereto, thereby converting a touch position into an electrical signal. FIG. 1 shows one example of a capacitive touch sensor panel of the prior art. In this example, a first conductive connecting layer 102 and a second connecting layer 107 may generate unwanted parasitic capacitance when the two connecting layers are too close to each other, resulting in a noise event. Therefore, there is room for improvement in the art.

### BRIEF DESCRIPTION OF THE FIGURES

Implementations of the present technology will now be described, by way of example only, with reference to the attached figures.

FIG. 1 is a cross-sectional view and a plan view illustrating a capacitive touch sensor panel of the prior art.

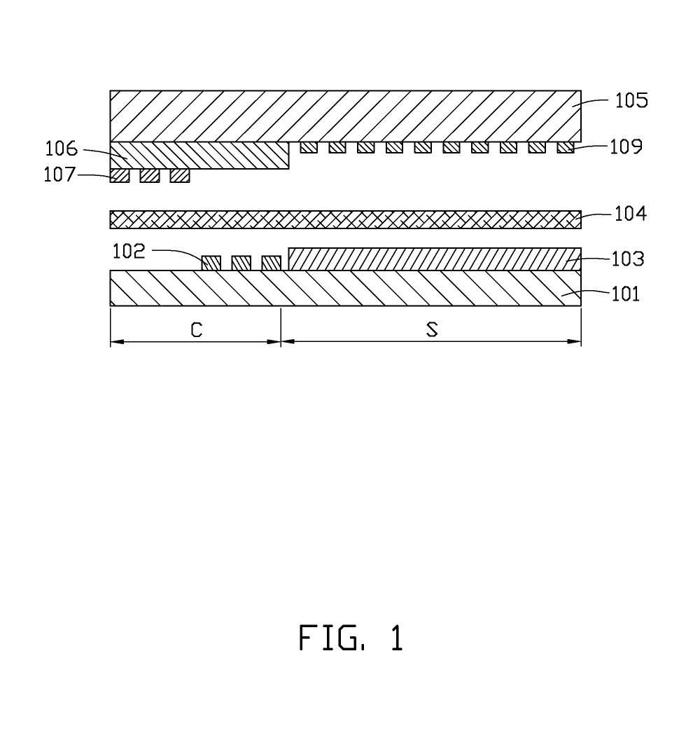

FIG. 2 is a cross-sectional view of a capacitive touch sensor panel in accordance with one embodiment of the present invention.

FIG. 3 is a cross-sectional view of a capacitive touch sensor panel in accordance with another embodiment of the present invention.

FIG. 4 is a cross-sectional view of a capacitive touch sensor panel in accordance with another embodiment of the present invention.

FIG. 5 is a cross-sectional view of a capacitive touch sensor panel in accordance with another embodiment of the present invention.

FIG. 6 is a cross-sectional view of a capacitive touch sensor panel in accordance with another embodiment of the present invention.

FIG. 7 is a cross-sectional view of a capacitive touch sensor panel in accordance with another embodiment of the present invention.

FIG. 8 is a cross-sectional view of a capacitive touch sensor panel in accordance with another embodiment of the present invention.

FIG. 9 is a cross-sectional view of a capacitive touch sensor panel in accordance with another embodiment of the present invention.

FIG. 10 is a cross-sectional view of a capacitive touch sensor panel in accordance with another embodiment of the present invention.

FIG. 11 is a cross-sectional view of a capacitive touch sensor panel in accordance with another embodiment of the present invention.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one. The present disclosure is described in relation to an electronic device with a plurality of internal components which can simultaneously communicate with a connected load beside the electronic device.

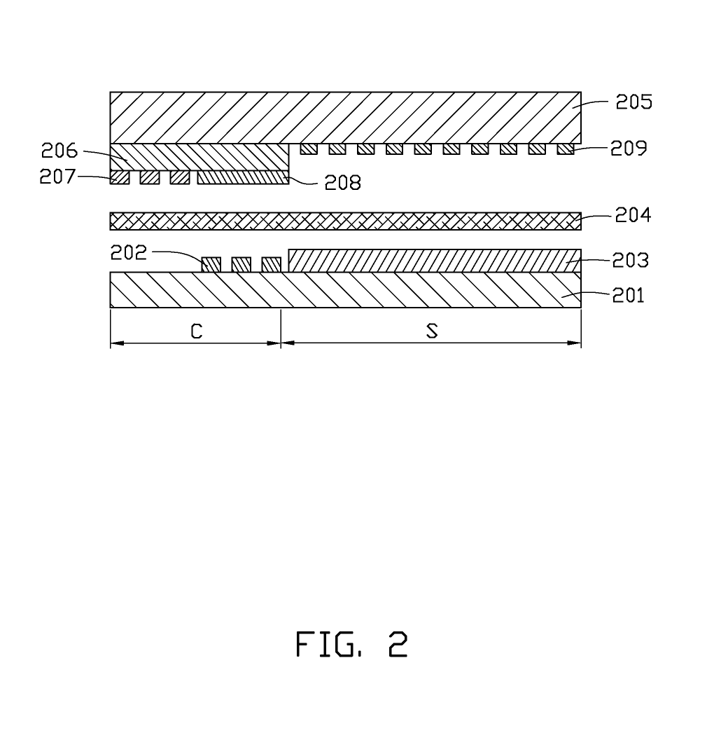

Embodiments of the invention are discussed below with reference to FIGS. 2-11. However, those skilled in the art will readily appreciate that the detailed description given herein with respect to these figures is for explanatory purposes as the invention extends beyond these limited embodiments.

FIG. 2 is a cross-sectional view illustrating a capacitive touch sensor panel in accordance with one embodiment of the present invention. The capacitive touch sensor panel comprises a first substrate 201 having a sensing region S and a connecting region C surrounding the sensing region S. The first substrate 201 may be made of flexible material, wherein the flexible material can be Poly Carbonate (PC), ARTON, Polyether Sulfone (PES), ZEONOR, Tri Acetyl Cellulose (TAC), Polyethylene Terephthalate (PET), or Polymethyl Methacrylate (PMMA). The first substrate 201 may also be made of inflexible material comprising glass, sapphire, or ceramics.

In the connecting region C, a first conductive connecting layer 202 is disposed on the first substrate 201. The first conductive connecting layer 202 may be formed from a transparent conductive material or an opaque conductive material according to conditions such as conductivity requirement. In the sensing region S, A first conductive layer 203 is also disposed on the first substrate 201. The first conductive layer 203 may be formed from a transparent conductive material and is electrically connected to the first conductive connecting layer 202.

The capacitive touch sensor panel also comprises a second substrate 205 which comprises a sensing region S and a connecting region C surrounding the sensing region S. In the connecting region C, an insulative opaque layer 206 is disposed under the second substrate 205, wherein the insulative opaque layer 206 may be made of insulative materials or colored ink. A second conductive connecting layer 207 and a grounding layer 208 are disposed under the insulative opaque layer 206, wherein the second conductive connecting layer 207 and grounding layer 208 are adjacent to each other, and the grounding layer 208 is disposed above the first conductive connecting layer 202 with approximately the same width of the first conductive connecting layer 202. On the other hand, in the sensing region S, a second conductive layer 209 is disposed under. The second conductive layer 209 may be formed from a transparent conductive material and is electrically connected to the second conductive connecting layer 207. The other side of the second substrate 205 may furthermore be a portion that is touched by a user's hand or an object.

The second substrate 205 may be formed from a flexible material similar to the flexible one the first substrate 201 is formed from. The second substrate 205 may furthermore be formed from inflexible material comprising glass, sapphire, or ceramics. On the other hand, the second conductive connecting layer 207 and the grounding layer 208 may be formed from a transparent conductive material or an opaque conductive material according to conditions such as conductivity requirement.

The capacitive touch sensor panel of this embodiment furthermore comprises an insulative layer 204 disposed between the first substrate 201 and the second substrate 205, wherein the insulative layer 204 prevents the electrical connectivity between the first conductive connecting layer 202, the grounding layer 208, and the second conductive connecting layer 207 as well as the first conductive layer 203 and the second conductive layer 209. The insulative layer 204 may be formed from a material comprising Optically Clear Adhesive (OCA) or Liquid Optically Clear Adhesive (LOCA).

Herein, the first conductive connecting layer 202 and the second conductive connecting layer 207, the first conductive layer 203 and second conductive layer 209, and the grounding layer 208 may be formed from a transparent conductive material comprising indium tin oxide (ITO), metal mesh, nano tube, graphene, or silver nanowire. The first conductive connecting layer 202 and the second conductive connecting layer 207 may also be formed from an opaque conductive material comprising silver paste, copper, molybdenum (Mo), or aluminum; whereas the grounding layer 208 may be formed from another opaque conductive material comprising similar color with the insulative opaque layer 206.

According to the embodiments of the present invention with the grounding layer 208 disposed, and thus the first conductive connecting layer 202 and the second conductive connecting layer 207 may reduce said parasitic capacitance.

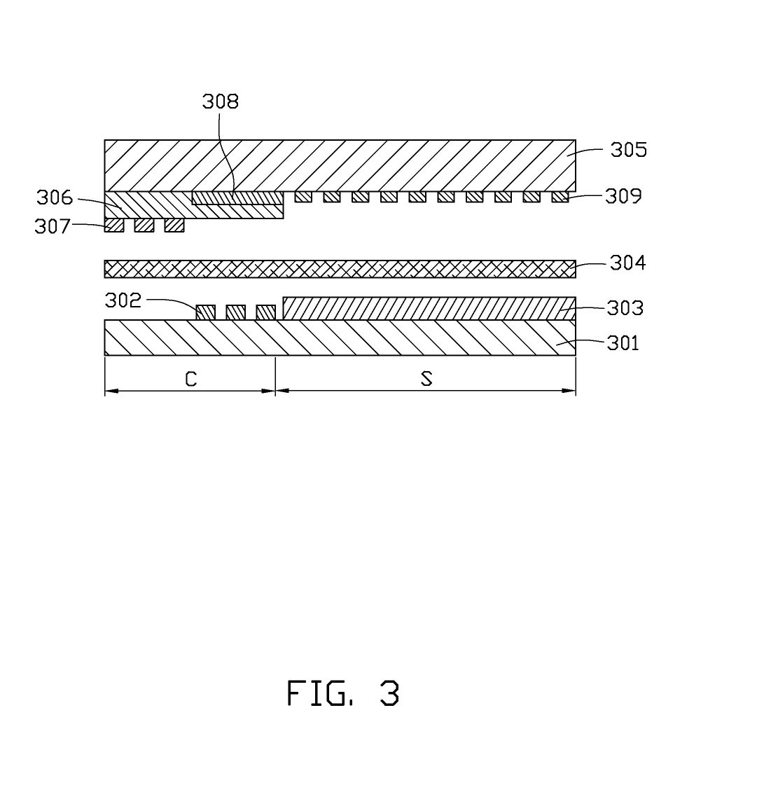

FIG. 3 is a cross-sectional view of a capacitive touch sensor panel from another embodiment. The capacitive touch sensor panel illustrated comprises a first substrate 301 having a sensing region S and a connecting region C surrounding the sensing region S. The first substrate 301 may be made of flexible material, wherein the flexible material can be Poly Carbonate (PC), ARTON, Polyether Sulfone (PES), ZEONOR, Tri Acetyl Cellulose (TAC), Polyethylene Terephthalate (PET), or Polymethyl Methacrylate (PMMA). The first substrate 301 may also be made of inflexible material comprising glass, sapphire, or ceramics.

In the connecting region C, a first conductive connecting layer 302 is disposed on the first substrate 301. The first conductive connecting layer 302 may be formed from a transparent conductive material or an opaque conductive material according to conditions such as conductivity requirement. In the sensing region S, A first conductive layer 303 is also disposed on the first substrate 301. The first conductive layer 303 may be formed from a transparent conductive material and is electrically connected to the first conductive connecting layer 302.

The capacitive touch sensor panel also comprises a second substrate 305 which comprises a sensing region S and a connecting region C surrounding the sensing region S. In the connecting region C, an insulative opaque layer 306 is disposed under the second substrate 305, wherein the insulative opaque layer 306 may be made of insulative materials or colored ink. A second conductive connecting layer 307 and a grounding layer 308 are disposed above the insulative opaque layer 306, wherein the grounding layer 308 is disposed above the first conductive connecting layer 302 with approximately the same width of the first conductive connecting layer 302. On the other hand, in the sensing region S, a second conductive layer 309 is disposed under. The second conductive layer 309 may be formed from a transparent conductive material and is electrically connected to the second conductive connecting layer 307. The other side of the second substrate 305 may furthermore be a portion that is touched by a user's hand or an object.

The second substrate 305 may be formed from a flexible material similar to the flexible one the first substrate 301 is formed from. The second substrate 305 may furthermore be formed from inflexible material comprising glass, sapphire, or ceramics. On the other hand, the second conductive connecting layer 307 and the grounding layer 308 may be formed from a transparent conductive material or an opaque conductive material according to conditions such as conductivity requirement.

The capacitive touch sensor panel of this embodiment furthermore comprises an insulative layer 304 disposed between the first substrate 301 and the second substrate 305, wherein the insulative layer 304 prevents the electrical connectivity of the first conductive connecting layer 302, the grounding layer 308, and the second conductive connecting layer 307 as well as the first conductive layer 303 and the second conductive layer 309. The insulative layer 304 may be formed from a material comprising Optically Clear Adhesive (OCA) or Liquid Optically Clear Adhesive (LOCA).

Herein, the first conductive connecting layer 302 and the second conductive connecting layer 307, the first conductive layer 303 and second conductive layer 309, and the grounding layer 308, may be formed from a transparent conductive material. The transparent conductive material comprises indium tin oxide (ITO), metal mesh, nano tube, graphene, or silver nanowire. The first conductive connecting layer 302 and the second conductive connecting layer 307 may also be formed from an opaque conductive material comprising silver paste, copper, molybdenum (Mo), or aluminum; whereas the grounding layer 308 may be formed from opaque conductive material comprising similar color with the insulative opaque layer 206.

According to the embodiments of the present invention with the grounding layer 308 disposed, and thus the first conductive connecting layer 302 and the second conductive connecting layer 307 may reduce said parasitic capacitance.

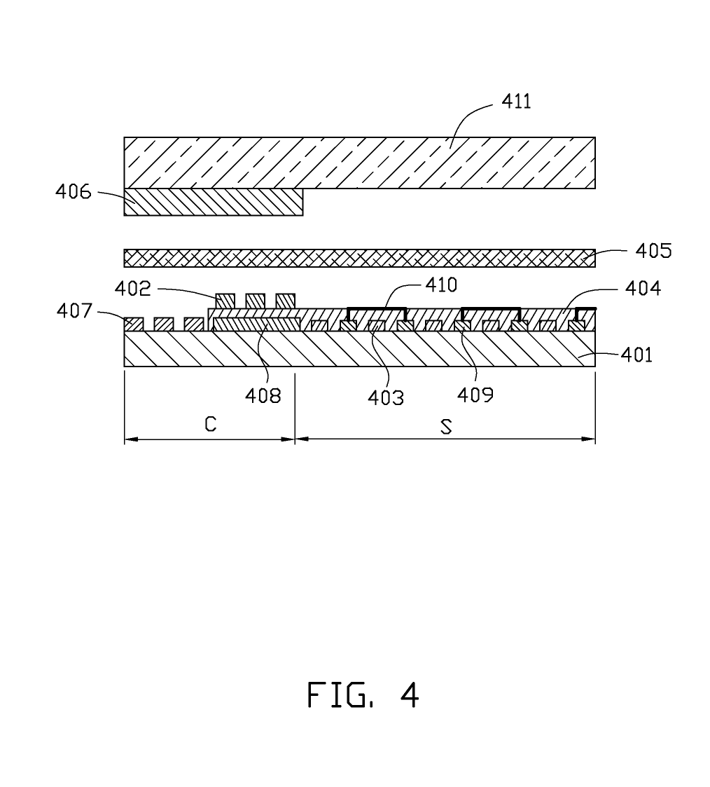

According to another embodiment of the present invention, referring to a cross-section view illustrated in FIG. 4, a capacitive touching sensor panel may comprise a substrate 401 having a sensing region S and a connecting region C surrounding the sensing region S. The substrate 401 may be made of flexible material, wherein the flexible material can be Poly Carbonate (PC), ARTON, Polyether Sulfone (PES), ZEONOR, Tri Acetyl Cellulose (TAC), Polyethylene Terephthalate (PET), or Polymethyl Methacrylate (PMMA). The substrate 401 may also be made of inflexible material comprising glass, sapphire, or ceramics.

In the connecting region C, a grounding layer 408 is disposed on the substrate 401. Above the grounding layer 408, a dielectric layer 404 is disposed on while a first conductive connecting layer 402 is disposed on said dielectric layer 404. The grounding layer 408 and the first conductive connecting layer 402 are insulatively separated by the dielectric layer 404. The dielectric layer 404 may comprises silicon nitride or silicon dioxide.

Furthermore the first conductive connecting layer 402 has approximately the same width of the grounding layer 408. Adjacent to the grounding layer 408, in the connecting region C, also comprises a second conductive connecting layer 407 disposed on the substrate 401. The grounding layer 408, the first conductive connecting layer 402 and the second conductive layer 407 may be formed from a transparent conductive material or an opaque conductive material according to conditions such as conductivity requirement.

In the sensing region S, A first conductive layer 403 is disposed on the substrate 401. The first conductive layer 403 comprises a plurality of conductive pattern disposed in a first direction and is electrically connected to the first conductive connecting layer 402. In said sensing region S, a second conductive layer 409 is also disposed on the substrate 401. The second conductive layer 409 comprises a plurality of conductive pattern disposed in a second direction, wherein the first conductive layer 403 and the second conductive layer 409 are orthogonally distributed. The second conductive layer 409 is electrically connected to the second conductive connecting layer 407. The first conductive layer 403 and the second conductive layer 409 are disposed to be insulatively separated by the dielectric layer 404. The patterns of the second conductive layer 409 then may be electrically connected by a conductive bridge 410. The first conductive layer 403 and the second conductive 409, and the conductive bridge 410 may be formed from a transparent conductive material.

An insulative layer 405 may be disposed above the first conductive connecting layer 402, the second conductive connecting layer 407, the first conductive layer 403, and the second conductive layer 409, wherein the insulative layer 405 is to avoid unexpected electrical connectivity between said layers. The insulative layer 405 may be formed from a material comprising Optically Clear Adhesive (OCA) or Liquid Optically Clear Adhesive (LOCA).

A protective cover 411 is disposed on the insulative layer 405. The protective cover 411 is formed from a material comprising glass, sapphire, poly carbonate (PC), polyvinyl chloride (PVC), Polyethylene Terephthalate (PET), or Polyimide (PI). An insulative opaque layer 406 is disposed under the protective cover 411 covering above the connecting region C of the substrate 401. Said insulative opaque layer 406 may be made of insulative materials or colored ink.

Herein, the first conductive connecting layer 402 and the second conductive connecting layer 407, the first conductive layer 403 and the second conductive layer 409, and the grounding layer 408 may be formed from a transparent conductive material. The transparent conductive material comprises indium tin oxide (ITO), metal mesh, nano tube, graphene, or silver nanowire. The first conductive connecting layer 402, the second conductive connecting layer 407, and the grounding layer 408 may also be formed from an opaque conductive material comprising silver paste, copper, molybdenum (Mo), or aluminum.

According to the embodiments of the present invention, with the grounding layer 408 disposed, and thus the first conductive connecting layer 402 and the second conductive connecting layer 407 may reduce said parasitic capacitance.

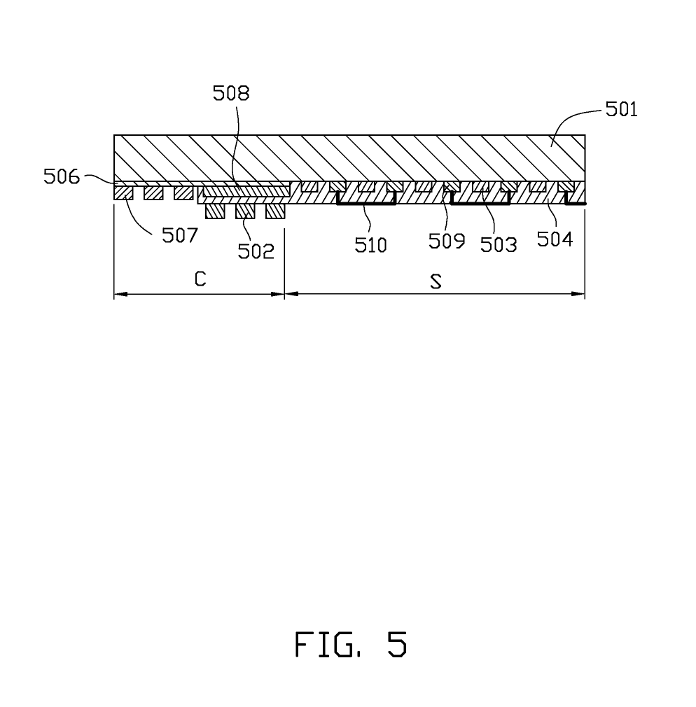

FIG. 5 is a cross-sectional view of a capacitive touch sensor panel from another embodiment. The capacitive touching sensor panel may comprise a substrate 501 having a sensing region S and a connecting region C surrounding the sensing region S. The substrate 501 may be made of a flexible material, wherein the flexible material can be Poly Carbonate (PC), ARTON, Polyether Sulfone (PES), ZEONOR, Tri Acetyl Cellulose (TAC), Polyethylene Terephthalate (PET), or Polymethyl Methacrylate (PMMA). The substrate 501 may also be made of an inflexible material comprising glass, sapphire, or ceramics.

In the connecting region C, an insulative opaque layer 506 is disposed under the substrate 501. The insulative opaque layer 506 may be made of insulative materials or colored ink. A grounding layer 508 is then disposed under the insulative opaque layer 506. Below the grounding layer 508, a dielectric layer 504 is disposed. Said dielectric layer 504 may comprises silicon nitride or silicon dioxide. A first conductive connecting layer 502 is disposed under the dielectric layer 504, covered by the grounding layer 508, and having approximately the same width of the grounding layer 508. The dielectric layer 504 prevents the grounding layer 508 and the first conductive connecting layer 502 from being electrically connected. On the other hand, a second conductive connecting layer 507 is also disposed under the insulative opaque layer 506 and adjacent to the grounding layer 508 in connecting region C. The grounding layer 508, the first conductive connecting layer 502 and the second conductive layer 507 may be formed from a transparent conductive material or an opaque conductive material according to conditions such as conductivity requirement.

In the sensing region S, A first conductive layer 503 is disposed on the substrate 501. The first conductive layer 503 comprises a plurality of conductive pattern disposed in a first direction and is electrically connected to the first conductive connecting layer 502. In said sensing region S, a second conductive layer 509 is also disposed on the substrate 501. The second conductive layer 509 comprises a plurality of conductive pattern disposed in a second direction, wherein the first conductive layer 503 and the second conductive layer are orthogonally distributed. The second conductive layer 509 is electrically connected to the second conductive connecting layer 507. The first conductive layer 503 and the second conductive layer 509 are disposed to be insulatively separated by the dielectric layer 504. The patterns of the second conductive layer then may be electrically connected by a conductive bridge 510. The first conductive layer 503 and the second conductive 509, and the conductive bridge 510 may be formed from a transparent conductive material.

Herein, the first conductive connecting layer 502 and the second conductive connecting layer 507, the first conductive layer 503 and second conductive layer 509, and the grounding layer 508 may be formed from a transparent conductive material. The transparent conductive material comprises indium tin oxide (ITO), metal mesh, nano tube, graphene, or silver nanowire. The first conductive connecting layer 502, the second conductive connecting layer 507, and the grounding layer 508 may also be formed from an opaque conductive material comprising silver paste, copper, molybdenum (Mo), or aluminum.

According to the embodiments of the present invention with the grounding layer 508 disposed, and thus the first conductive connecting layer 502 and the second conductive connecting layer 507 may reduce said parasitic capacitance.

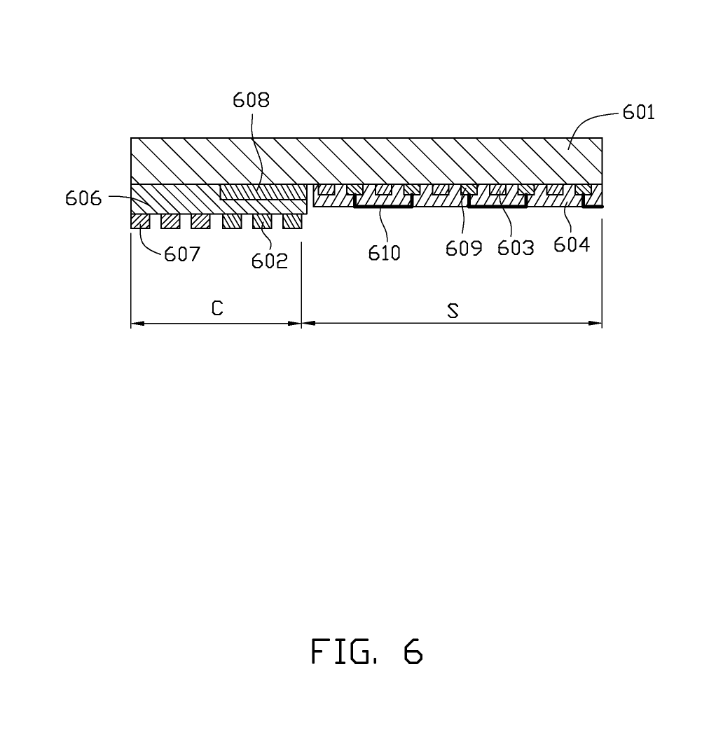

FIG. 6 is a cross-sectional view of a capacitive touch sensor panel from another embodiment similar to the embodiment illustrated in FIG. 5. The capacitive touching sensor panel may comprise a substrate 601 having a sensing region S and a connecting region C surrounding the sensing region S. The substrate 601 may be made of a flexible material, wherein the flexible material can be Poly Carbonate (PC), ARTON, Polyether Sulfone (PES), ZEONOR, Tri Acetyl Cellulose (TAC), Polyethylene Terephthalate (PET), or Polymethyl Methacrylate (PMMA). The substrate 601 may also be made of an inflexible material comprising glass, sapphire, or ceramics.

In the connecting region C, a grounding layer 608 is then disposed under the substrate 601. An insulative opaque layer 606 is then disposed under the grounding layer 608. The insulative opaque layer 606 may be made of insulative materials or colored ink. A first conductive connecting layer 602 is disposed under the insulative opaque layer 606, covered by the grounding layer 608, and having approximately the same width of the grounding layer 608. On the other hand, a second conductive connecting layer 607 is also disposed under the insulative opaque layer 606 and adjacent to the first conductive connecting layer 602 in connecting region C. The grounding layer 608, the first conductive connecting layer 602 and the second conductive layer 607 may be formed from a transparent conductive material or an opaque conductive material according to conditions such as conductivity requirement.

In the sensing region S, A first conductive layer 603 is disposed on the substrate 601. The first conductive layer 603 comprises a plurality of conductive pattern disposed in a first direction and is electrically connected to the first conductive connecting layer 602. In said sensing region S, a second conductive layer 609 is also disposed on the substrate 601. The second conductive layer 609 comprises a plurality of conductive pattern disposed in a second direction, wherein the first conductive layer 603 and the second conductive layer are orthogonally distributed. The second conductive layer 609 is electrically connected to the second conductive connecting layer 607. The first conductive layer 603 and the second conductive layer 609 are disposed to be insulatively separated by a dielectric layer 604. The patterns of the second conductive layer then may be electrically connected by a conductive bridge 610. The first conductive layer 603 and the second conductive 609, and the conductive bridge 610 may be formed from a transparent conductive material, and the dielectric layer 604 may comprises silicon nitride or silicon dioxide. The dielectric layer 604 prevents the first conductive layer 603 and the second conductive layer 609 from being electrically connected.

Herein, the first conductive connecting layer 602 and the second conductive connecting layer 607, the first conductive layer 603 and second conductive layer 609, and the grounding layer 608 may be formed from a transparent conductive material. The transparent conductive material comprises indium tin oxide (ITO), metal mesh, nano tube, graphene, or silver nanowire. The first conductive connecting layer 602, the second conductive connecting layer 607 may also be formed from an opaque conductive material comprising silver paste, copper, molybdenum (Mo), or aluminum; whereas the grounding layer 608 may be formed from opaque conductive material comprising similar color with the insulative opaque layer 606.

According to the embodiments of the present invention, with the grounding layer 608 disposed, and thus the first conductive connecting layer 602 and the second conductive connecting layer 607 may reduce said parasitic capacitance.

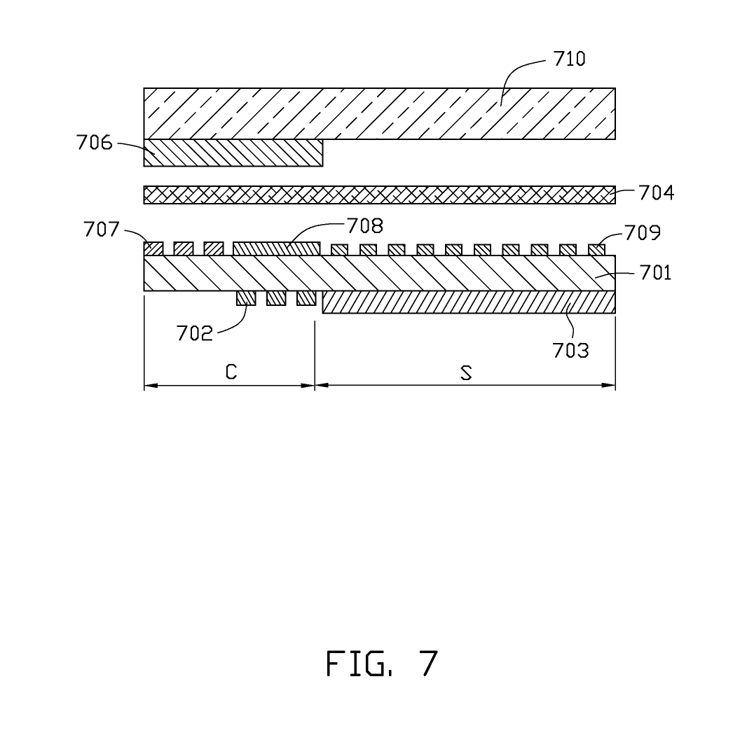

FIG. 7 is a cross-sectional view illustrating a capacitive touch sensor panel in accordance with one embodiment of the present invention. The capacitive touch sensor panel comprises a substrate 701 having a sensing region S and a connecting region C surrounding the sensing region S. The substrate 701 may be made of a flexible material, wherein the flexible material can be Poly Carbonate (PC), ARTON, Polyether Sulfone (PES), ZEONOR, Tri Acetyl Cellulose (TAC), Polyethylene Terephthalate (PET), or Polymethyl Methacrylate (PMMA). The substrate 701 may also be made of an inflexible material comprising glass, sapphire, or ceramics.

In the connecting region C, a first conductive connecting layer 702 is disposed under the substrate 701. On the same substrate 701, also in connecting region C, a second conductive connecting layer 707 and a grounding layer 708 are disposed above, wherein the second conductive connecting layer 707 and the grounding layer 708 are adjacent to each other, and the grounding layer 708 is disposed above the first conductive connecting layer 702 with approximately the same width of the first conductive connecting layer 702. The first conductive connecting layer 702, the second conductive connecting layer 707, and the grounding layer 708 may be formed from a transparent conductive material or an opaque conductive material according to conditions such as conductivity requirement.

On the other hand, in the sensing region S, A first conductive layer 703 is disposed under the substrate 701 while a second conductive layer 709 is disposed above the substrate 701. The first conductive layer 703 is electrically connected to the first conductive connecting layer 702, and the second conductive layer 709 is electrically connected to the second conductive connecting layer 707. Both the first conductive layer 703 and the second conductive layer 709 may be formed from a transparent conductive material.

An insulative layer 704 may be disposed on the second conductive connecting layer 707, the grounding layer 708, and the second conductive layer 709, wherein the insulative layer 704 is to avoid unexpected electrical connectivity between said layers. The insulative layer 704 may be formed from a material comprising Optically Clear Adhesive (OCA) or Liquid Optically Clear Adhesive (LOCA).

A protective cover 710 is disposed on the insulative layer 704. The protective cover 710 is formed from a material comprising glass, sapphire, Poly Carbonate (PC), Polyvinyl Chloride (PVC), Polyethylene Terephthalate (PET), or Polyimide (PI). An insulative opaque layer 706 is disposed under the protective cover 710 covering above the connecting region C of the substrate 701. Said insulative opaque layer 706 may be made of insulative materials or colored ink.

Herein, the first conductive connecting layer 702 and the second conductive connecting layer 707, the first conductive layer 703 and second conductive layer 709, and the grounding layer 708 may be formed from a transparent conductive material. The transparent conductive material comprises indium tin oxide (ITO), metal mesh, nano tube, graphene, or silver nanowire. The first conductive connecting layer 702, the second conductive connecting layer 707, and the grounding layer 708 may also be formed from an opaque conductive material comprising silver paste, copper, molybdenum (Mo), or aluminum.

According to the embodiments of the present invention, with the grounding layer 708 disposed, and thus the first conductive connecting layer 702 and the second conductive connecting layer 707 may reduce said parasitic capacitance.

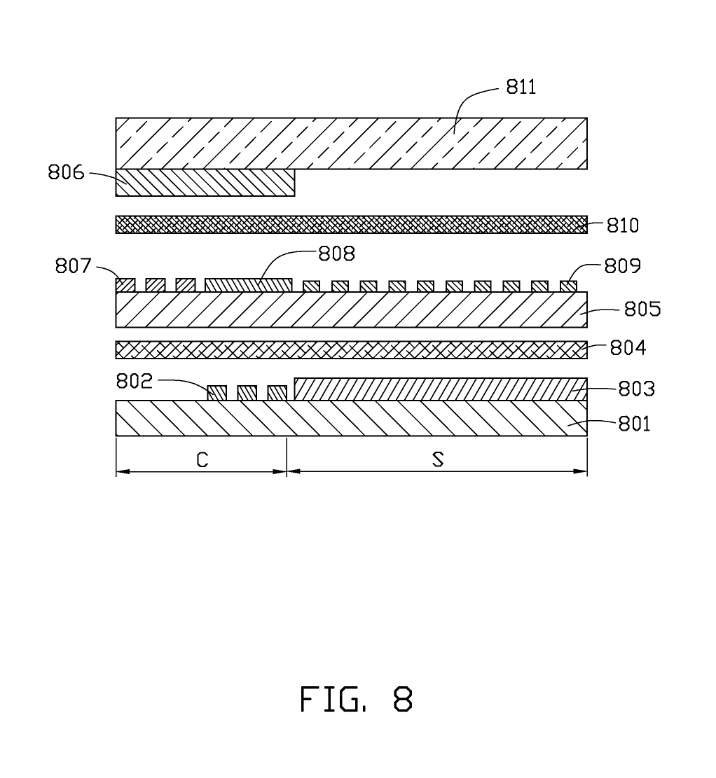

FIG. 8 is a cross-sectional view illustrating a capacitive touch sensor panel in accordance with one embodiment of the present invention. The capacitive touch sensor panel comprises a substrate 801 having a sensing region S and a connecting region C surrounding the sensing region S. The substrate 801 may be made of a flexible material, wherein the flexible material can be Poly Carbonate (PC), ARTON, Polyether Sulfone (PES), ZEONOR, Tri Acetyl Cellulose (TAC), Polyethylene Terephthalate (PET), or Polymethyl Methacrylate (PMMA). The substrate 801 may also be made of an inflexible material comprising glass, sapphire, or ceramics.

In the connecting region C, a first conductive connecting layer 802 is disposed on the first substrate 801. The first conductive connecting layer 802 may be formed from a transparent conductive material or an opaque conductive material according to conditions such as conductivity requirement. In the sensing region S, A first conductive layer 803 is also disposed on the first substrate 801. The first conductive layer 803 may be formed from a transparent conductive material and is electrically connected to the first conductive connecting layer 802.

A first insulative layer 804 may be disposed on the first conductive connecting layer 802 and the first conductive layer 803, wherein the first insulative layer 804 is to avoid unexpected electrical connectivity between said layers. The first insulative layer 804 may be formed from a material comprising Optically Clear Adhesive (OCA) or Liquid Optically Clear Adhesive (LOCA).

The capacitive touch sensor panel also comprises a second substrate 805 which comprises a sensing region S and a connecting region C surrounding the sensing region S. In the connecting region C, a second conductive connecting layer 807 and a grounding layer 808 are disposed on the second substrate 805, wherein the second conductive connecting layer 807 and the grounding layer 808 are adjacent to each other and the grounding layer 808 is disposed above the first conductive connecting layer 802 with approximately the same width of the first conductive connecting layer 802. On the other hand, in the sensing region S, a second conductive layer 809 is disposed on the second substrate 805. The second conductive layer 809 may be formed from a transparent conductive material and is electrically connected to the second conductive connecting layer 807.

The second substrate 805 may be formed from flexible materials similar to the flexible ones the substrate 801 is formed from. The substrate 805 may furthermore be formed from inflexible material comprising glass, sapphire, or ceramics. On the other hand, the second conductive connecting layer 807 and the grounding layer 808 may be formed from a transparent conductive material or an opaque conductive material according to conditions such as conductivity requirement.

A second insulative layer 810 may be disposed on the second conductive connecting layer 807, the grounding layer 808, and the second conductive layer 809, wherein the second insulative layer 810 is to avoid unexpected electrical connectivity between said layers. The insulative layer 804 may be formed from a material comprising Optically Clear Adhesive (OCA) or Liquid Optically Clear Adhesive (LOCA).

A protective cover 811 is disposed on the second insulative layer 810. The protective cover 811 is formed from a material comprising glass, sapphire, Poly Carbonate (PC), Polyvinyl Chloride (PVC), Polyethylene Terephthalate (PET), or Polyimide (PI). An insulative opaque layer 806 is disposed under the protective cover 811 covering above the connecting region C of the substrate 801. Said insulative opaque layer 806 may be made of insulative materials or colored ink.

Herein, the first conductive connecting layer 802 and the second conductive connecting layer 807, the first conductive layer 803 and second conductive layer 809, and the grounding layer 808 may be formed from a transparent conductive material. The transparent conductive material comprises indium tin oxide (ITO), metal mesh, nano tube, graphene, or silver nanowire. The first conductive connecting layer 802, the second conductive connecting layer 807, and the grounding layer 808 may also be formed from an opaque conductive material comprising silver paste, copper, molybdenum (Mo), or aluminum.

According to the embodiments of the present invention with the grounding layer 808 disposed, and thus the first conductive connecting layer 802 and the second conductive connecting layer 807 may reduce said parasitic capacitance.

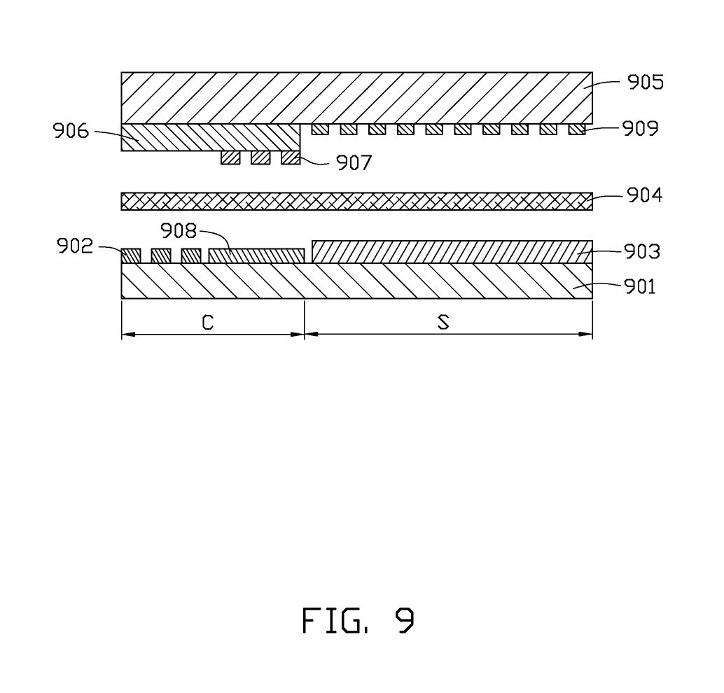

FIG. 9 is a cross-sectional view illustrating a capacitive touch sensor panel in accordance with one embodiment of the present invention. The capacitive touch sensor panel comprises a first substrate 901 having a sensing region S and a connecting region C surrounding the sensing region S. The first substrate 901 may be made of flexible material, wherein the flexible material can be Poly Carbonate (PC), ARTON, Polyether Sulfone (PES), ZEONOR, Tri Acetyl Cellulose (TAC), Polyethylene Terephthalate (PET), or Polymethyl Methacrylate (PMMA). The first substrate 901 may also be made of inflexible material comprising glass, sapphire, or ceramics.

In the connecting region C, a first conductive connecting layer 902 is disposed on the first substrate 901. On the said connecting region C, a grounding layer 908 is disposed above, wherein the first conductive connecting layer 902 and grounding layer 908 are adjacent to each other. The first conductive connecting layer 902 and the grounding layer 908 may be formed from a transparent conductive material or an opaque conductive material according to conditions such as conductivity requirement. In the sensing region S, A first conductive layer 903 is also disposed on the first substrate 901. The first conductive layer 903 may be formed from a transparent conductive material and is electrically connected to the first conductive connecting layer 902.

The capacitive touch sensor panel also comprises a second substrate 905 which comprises a sensing region S and a connecting region C surrounding the sensing region S. In the connecting region C, an insulative opaque layer 906 is disposed under the second substrate 905, wherein the insulative opaque layer 906 may be made of insulative materials or colored ink. A second conductive connecting layer 907 is disposed under the insulative opaque layer 906, wherein the second conductive connecting layer 907 is disposed above the grounding layer 908 with approximately the same width of the grounding layer 908. On the other hand, in the sensing region S, a second conductive layer 909 is disposed under the second substrate 905. The second conductive layer 909 may be formed from a transparent conductive material and is electrically connected to the second conductive connecting layer 907. The other side of the second substrate 905 may furthermore be a portion that is touched by a user's hand or an object.

The second substrate 905 may be formed from a flexible material similar to the flexible one the first substrate 901 is formed from. The second substrate 905 may furthermore be formed from inflexible material comprising glass, sapphire, or ceramics. On the other hand, the second conductive connecting layer 907 may be formed from a transparent conductive material or an opaque conductive material according to conditions such as conductivity requirement.

The capacitive touch sensor panel of this embodiment furthermore comprises an insulative layer 904 disposed between the first substrate 901 and the second substrate 905, wherein the insulative layer 904 prevents the electrical connectivity between the first conductive connecting layer 902, the grounding layer 908, and the second conductive connecting layer 907 as well as the first conductive layer 903 and the second conductive layer 909. The insulative layer 904 may be formed from a material comprising Optically Clear Adhesive (OCA) or Liquid Optically Clear Adhesive (LOCA).

Herein, the first conductive connecting layer 902 and the second conductive connecting layer 907, the first conductive layer 903 and second conductive layer 909, and the grounding layer 908 may be formed from a transparent conductive material comprising indium tin oxide (ITO), metal mesh, nano tube, graphene, or silver nanowire. The first conductive connecting layer 902 and the second conductive connecting layer 907 may also be formed from an opaque conductive material comprising silver paste, copper, molybdenum (Mo), or aluminum; whereas the grounding layer 908 may be formed from another opaque conductive material comprising similar color with the insulative opaque layer 906.

According to the embodiments of the present invention with the grounding layer 908 disposed, and thus the first conductive connecting layer 902 and the second conductive connecting layer 907 may reduce said parasitic capacitance.

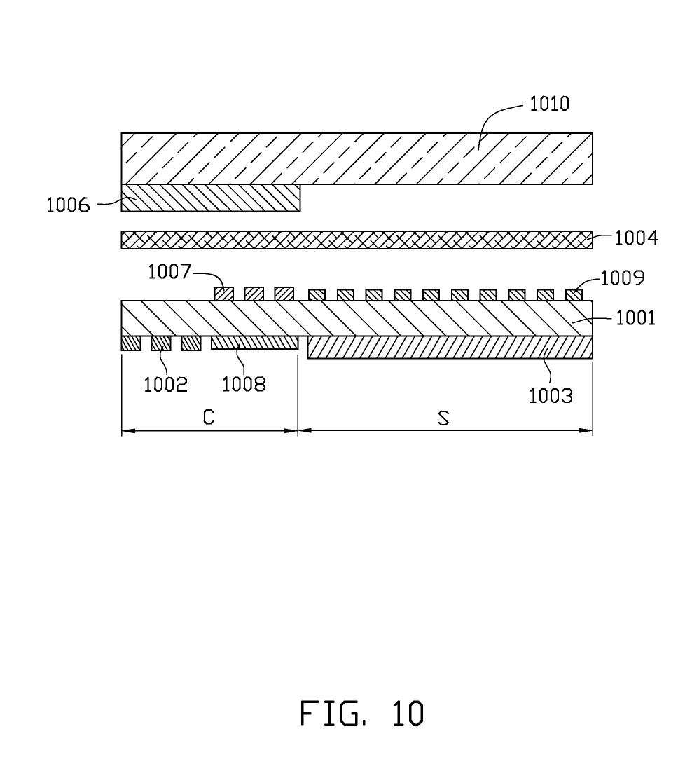

FIG. 10 is a cross-sectional view illustrating a capacitive touch sensor panel in accordance with one embodiment of the present invention. The capacitive touch sensor panel comprises a substrate 1001 having a sensing region S and a connecting region C surrounding the sensing region S. The substrate 1001 may be made of a flexible material, wherein the flexible material can be Poly Carbonate (PC), ARTON, Polyether Sulfone (PES), ZEONOR, Tri Acetyl Cellulose (TAC), Polyethylene Terephthalate (PET), or Polymethyl Methacrylate (PMMA). The substrate 1001 may also be made of an inflexible material comprising glass, sapphire, or ceramics.

In the connecting region C, a first conductive connecting layer 1002 and a grounding layer 1008 are disposed under the substrate 1001, wherein the first conductive connecting layer 1002 and the grounding layer 1008 are adjacent to each other. On the same substrate 1001, also in connecting region C, a second conductive connecting layer 1007 is disposed above, wherein the grounding layer 1008 is disposed under the second conductive connecting layer 1007 with approximately the same width of the second conductive connecting layer 1007. The first conductive connecting layer 1002, the second conductive connecting layer 1007, and the grounding layer 1008 may be formed from a transparent conductive material or an opaque conductive material according to conditions such as conductivity requirement.

On the other hand, in the sensing region S, A first conductive layer 1003 is disposed under the substrate 1001 while a second conductive layer 1009 is disposed above the substrate 1001. The first conductive layer 1003 is electrically connected to the first conductive connecting layer 1002, and the second conductive layer 1009 is electrically connected to the second conductive connecting layer 1007. Both the first conductive layer 1003 and the second conductive layer 1009 may be formed from a transparent conductive material.

An insulative layer 1004 may be disposed on the second conductive connecting layer 1007, the grounding layer 1008, and the second conductive layer 1009, wherein the insulative layer 1004 is to avoid unexpected electrical connectivity between said layers. The insulative layer 1004 may be formed from a material comprising Optically Clear Adhesive (OCA) or Liquid Optically Clear Adhesive (LOCA).

A protective cover 1010 is disposed on the insulative layer 1004. The protective cover 1010 is formed from a material comprising glass, sapphire, Poly Carbonate (PC), Polyvinyl Chloride (PVC), Polyethylene Terephthalate (PET), or Polyimide (PI). An insulative opaque layer 1006 is disposed under the protective cover 1010 covering above the connecting region C of the substrate 1001. Said insulative opaque layer 1006 may be made of insulative materials or colored ink.

Herein, the first conductive connecting layer 1002 and the second conductive connecting layer 1007, the first conductive layer 1003 and second conductive layer 1009, and the grounding layer 1008 may be formed from a transparent conductive material. The transparent conductive material comprises indium tin oxide (ITO), metal mesh, nano tube, graphene, or silver nanowire. The first conductive connecting layer 1002, the second conductive connecting layer 1007, and the grounding layer 1008 may also be formed from an opaque conductive material comprising silver paste, copper, molybdenum (Mo), or aluminum.

According to the embodiments of the present invention, with the grounding layer 1008 disposed, and thus the first conductive connecting layer 1002 and the second conductive connecting layer 1007 may reduce said parasitic capacitance.

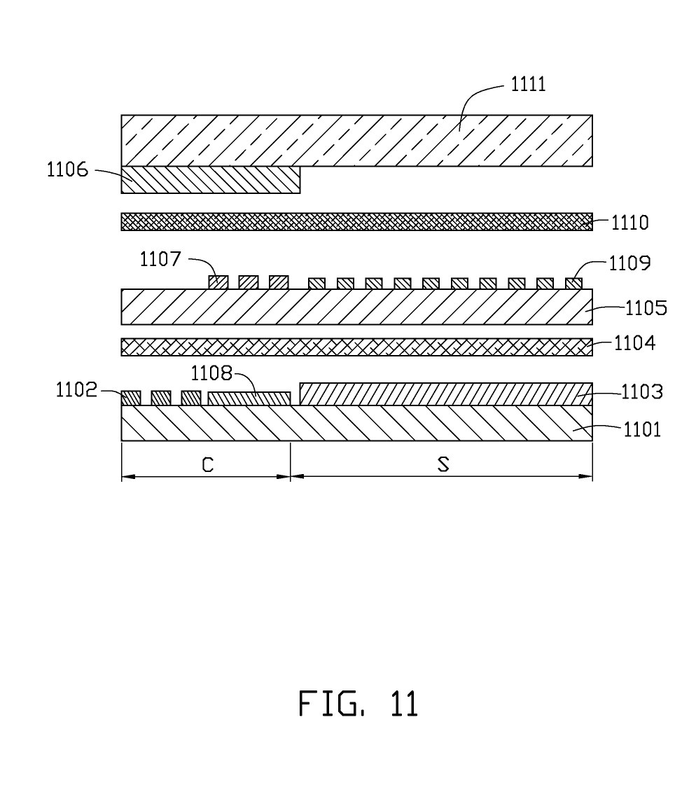

FIG. 11 is a cross-sectional view illustrating a capacitive touch sensor panel in accordance with one embodiment of the present invention. The capacitive touch sensor panel comprises a substrate 1101 having a sensing region S and a connecting region C surrounding the sensing region S. The substrate 1101 may be made of a flexible material, wherein the flexible material can be Poly Carbonate (PC), ARTON, Polyether Sulfone (PES), ZEONOR, Tri Acetyl Cellulose (TAC), Polyethylene Terephthalate (PET), or Polymethyl Methacrylate (PMMA). The substrate 1101 may also be made of an inflexible material comprising glass, sapphire, or ceramics.

In the connecting region C, a first conductive connecting layer 1102 is disposed on the first substrate 1101. On the said connecting region C, a grounding layer 1108 is disposed on, wherein the second conductive connecting layer 1102 and grounding layer 1108 are adjacent to each other. The first conductive connecting layer 1102 and the grounding layer 1108 may be formed from a transparent conductive material or an opaque conductive material according to conditions such as conductivity requirement. In the sensing region S, A first conductive layer 1103 is also disposed on the first substrate 1101. The first conductive layer 1103 may be formed from a transparent conductive material and is electrically connected to the first conductive connecting layer 1102.

A first insulative layer 1104 may be disposed on the first conductive connecting layer 1102 and the first conductive layer 1103, wherein the first insulative layer 1104 is to avoid unexpected electrical connectivity between said layers. The first insulative layer 1104 may be formed from a material comprising Optically Clear Adhesive (OCA) or Liquid Optically Clear Adhesive (LOCA).

The capacitive touch sensor panel also comprises a second substrate 1105 which comprises a sensing region S and a connecting region C surrounding the sensing region S. In the connecting region C, a second conductive connecting layer 1107 is disposed on the second substrate 1105, wherein the second conductive connecting layer 1107 is disposed above the grounding layer 1108 with approximately the same width of the second conductive connecting layer 1107. On the other hand, in the sensing region S, a second conductive layer 1109 is disposed on the second substrate 1105. The second conductive layer 1109 may be formed from a transparent conductive material and is electrically connected to the second conductive connecting layer 1107.

The second substrate 1105 may be formed from flexible materials similar to the flexible ones the substrate 1101 is formed from. The substrate 1105 may furthermore be formed from inflexible material comprising glass, sapphire, or ceramics. On the other hand, the second conductive connecting layer 1107 may be formed from a transparent conductive material or an opaque conductive material according to conditions such as conductivity requirement.

A second insulative layer 1110 may be disposed on the second conductive connecting layer 1107, the grounding layer 1108, and the second conductive layer 1109, wherein the second insulative layer 1110 is to avoid unexpected electrical connectivity between said layers. The insulative layer 1104 may be formed from a material comprising Optically Clear Adhesive (OCA) or Liquid Optically Clear Adhesive (LOCA).

A protective cover 1111 is disposed on the second insulative layer 1110. The protective cover 1111 is formed from a material comprising glass, sapphire, Poly Carbonate (PC), Polyvinyl Chloride (PVC), Polyethylene Terephthalate (PET), or Polyimide (PI). An insulative opaque layer 1106 is disposed under the protective cover 1111 covering above the connecting region C of the substrate 1101. Said insulative opaque layer 1106 may be made of insulative materials or colored ink.

Herein, the first conductive connecting layer 1102 and the second conductive connecting layer 1107, the first conductive layer 1103 and second conductive layer 1109, and the grounding layer 1108 may be formed from a transparent conductive material. The transparent conductive material comprises indium tin oxide (ITO), metal mesh, nano tube, graphene, or silver nanowire. The first conductive connecting layer 1102, the second conductive connecting layer 1107, and the grounding layer 1108 may also be formed from an opaque conductive material comprising silver paste, copper, molybdenum (Mo), or aluminum.

According to the embodiments of the present invention with the grounding layer 1108 disposed, and thus the first conductive connecting layer 1102 and the second conductive connecting layer 1107 may reduce said parasitic capacitance.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims

What is claimed is:

1. A capacitive touch sensor panel, comprising:
a first substrate comprising a connecting region and a sensing region;
a first conductive connecting layer disposed on the first substrate in the connecting region;
a grounding layer disposed on the first substrate and adjacent to the first conductive connecting layer in the connecting region;
a first conductive layer disposed on the first substrate in the sensing region;
an insulative layer disposed on the first conductive connecting layer, the grounding layer, and the first conductive layer;
a second substrate comprising a connecting region and a sensing region;
an insulative opaque layer disposed under the second substrate in the connecting region;
a second conductive connecting layer disposed under the insulative opaque layer and above the grounding layer with approximately a same width of the grounding layer; and;
a second conductive layer disposed under the second substrate in the sensing region.

2. The capacitive touch sensor panel of claim 1, wherein the first substrate is formed from flexible material.

3. The capacitive touch sensor panel of claim 2, wherein the flexible material comprises Poly Carbonate (PC), ARTON, Polyether Sulfone (PES), ZEONOR, Tri Acetyl Cellulose (TAC), Polyethylene Terephthalate (PET), or Polymethyl Methacrylate (PMMA).

4. The capacitive touch sensor panel of claim 1, wherein the first substrate is formed from inflexible material.

5. The capacitive touch sensor panel of claim 4, wherein the inflexible material comprises glass, sapphire, or ceramic.

6. The capacitive touch sensor panel of claim 1, wherein the first conductive connecting layer, the second conductive connecting layer, and the grounding layer are formed from transparent conductive material.

7. The capacitive touch sensor panel of claim 6, wherein the transparent conductive material comprises indium tin oxide (ITO), metal mesh, carbon nano tube, graphene, or silver nanowire.

8. The capacitive touch sensor panel of claim 1, wherein the first conductive connecting layer, the second conductive connecting layer, and the grounding layer are formed from opaque conductive material.

9. The capacitive touch sensor panel of claim 8, wherein the opaque conductive material comprising silver paste, copper, molybdenum (Mo), or aluminum.

10. The capacitive touch sensor panel of claim 1, wherein the first conductive layer and the second conductive layer are formed from transparent conductive material.

11. The capacitive touch sensor panel of claim 10, wherein the transparent conductive material comprises indium tin oxide (ITO), metal mesh, carbon nano tube, graphene, or silver nanowire.

12. The capacitive touch sensor panel of claim 1, wherein the insulative layer comprises Optically Clear Adhesive (OCA) or Liquid Optically Clear Adhesive (LOCA).

13. A capacitive touch sensor panel, comprising:
a substrate comprising a connecting region and a sensing region;
a first conductive connecting layer disposed under the substrate in the connecting region;
a grounding layer disposed under the substrate and adjacent to the first conductive connecting layer in the connecting region;
a second conductive connecting layer disposed above the substrate and above the grounding layer with approximately the same width of the grounding layer in the connecting region;
a first conductive layer disposed under the substrate in the sensing region;
a second conductive layer disposed above the substrate in the sensing region.
an insulative layer disposed on the second conductive connecting layer and the second conductive layer;
a protective cover disposed on the insulative layer; and
an insulative opaque layer disposed under the substrate in the connecting region.

14. The capacitive touch sensor panel of claim 13, wherein the substrate is formed from flexible material.

15. The capacitive touch sensor panel of claim 13, wherein the substrate is formed from inflexible material.

16. The capacitive touch sensor panel of claim 13, wherein the first conductive connecting layer, the grounding layer, and the second conductive connecting layer are formed from transparent conductive material.

17. The capacitive touch sensor panel of claim 13, wherein the first conductive connecting layer, the grounding layer, and the second conductive connecting layer are formed from opaque conductive material.

18. The capacitive touch sensor panel of claim 13, wherein the first conductive layer and the second conductive layer are formed from transparent conductive material.

19. A capacitive touch sensor panel, comprising:
a first substrate comprising a connecting region and a sensing region;
a first conductive connecting layer disposed on the first substrate in the connecting region;
a grounding layer disposed on the first substrate and adjacent to the first conductive connecting layer in the connecting region;
a first conductive layer disposed on the first substrate in the sensing region;
a second substrate comprising a connecting region and a sensing region;
a second conductive connecting layer disposed on the second substrate and above the grounding layer with approximately the same width of the grounding layer in the connecting region;
a second conductive layer disposed under the second substrate in the sensing region;
a protective cover disposed on the second conductive connecting layer and the second conductive layer; and
an insulative opaque layer disposed under the protective cover in the connecting region.

20. The capacitive touch sensor panel of claim 19, wherein the first substrate and the second substrate are formed from flexible material.

21. The capacitive touch sensor panel of claim 19, wherein the first substrate and the second substrate are formed from inflexible material.

22. The capacitive touch sensor panel of claim 19, wherein the first conductive connecting layer, the grounding layer, and the second conductive connecting layer are formed from transparent conductive material.

23. The capacitive touch sensor panel of claim 19, wherein the first conductive connecting layer, the grounding layer, and the second conductive connecting layer are formed from opaque conductive material.

24. The capacitive touch sensor panel of claim 19, wherein the first conductive layer and the second conductive layer are formed from transparent conductive material.
